(19) United States
(12) Patent Application Publication
(10) Pub. No.: US 2011/0266232 A1
(43) Pub. Date: Nov. 3, 2011

(54) SHELVING SYSTEM WITH VIDEO CAPABILITY

(76) Inventors: Shawn Kahler, Heath, TX (US); Steven Kramer, Heath, TX (US); Paul D'Alessandro, Rockwall, TX (US); John Clontz, Heath, TX (US)

(21) Appl. No.: 13/104,700

(22) Filed: May 10, 2011

Related U.S. Application Data
(63) Continuation-in-part of application No. 12/518,241, filed on Jun. 17, 2009.
(60) Provisional application No. 61/333,115, filed on May 10, 2010.

(51) Int. Cl. A47F 7/00; H04N 5/775; G09F 7/00

(52) U.S. Cl. 211/26; 40/584; 386/230; 386/E05.003

(57) ABSTRACT

A display shelf for use, for example, in retail stores includes a product-supporting surface and a forwardly positioned display surface extending downwardly and forwardly from the front of the product-supporting surface. A video device with video content is secured to the shelf with the screen of the device visible though an aperture in the display surface and through a second aperture in an advertising sign that covers at least some of the display surface. A proximity sensor is provided to initiate playback of the content stored on the video device when the presence of a customer in the vicinity of the shelf is detected. Control buttons extend through registered openings in the display surface and sign. Each button, when operated, initiates playback of a particular one of the different videos stored on the device. Indicia on the sign adjacent each button provide information about the content of the respective videos. The customer can, by selecting a particular button, play of any one of a number of recordings stored on the video device that the customer wishes to see.

### CROSS-REFERENCE TO RELATED APPLICATION

This application claims the benefit of priority from U.S. Provisional Application Ser. No. 61/333,115 filed on May 10, 2010 and this is a continuation-in-part of co-pending U.S. patent application Ser. No. 12/518,241 filed on Dec. 7, 2007.

### FIELD OF THE INVENTION

The present invention relates to shelving systems for displaying products.

### BACKGROUND OF THE INVENTION

Co-pending patent application Ser. No. 12/518,241 (the “Co-pending Application”) discloses a retail shelving system comprising a secure enclosure beneath a product-supporting surface of a shelf and electronic components within the enclosure including video display equipment adapted to display audio/video content to customers standing in front of the shelf. The entire contents of the Co-pending Application, including its drawings, are incorporated by reference into this application.

### SUMMARY OF THE INVENTION

In the shelving system of the present invention, the shelf comprises a product-supporting surface and a forwardly inclined display surface extending downwardly from the front edge of the product-supporting surface. The display surface includes an aperture and a video display device supported by the shelf with its screen positioned in the aperture so that video displayed on a screen of the device is visible to a customer standing in front of the shelf. The video device is preferably a video monitor with integrated speakers.

In one embodiment of the invention, a plurality of spaced-apart openings is provided in the display surface. A plurality of operating buttons extends through a respective opening and, when pressed by a customer, causes the video device to play a video having particular, selected, subject matter relevant to, for example, products on the shelf. The nature of the available video subject matter is indicated by an illustrated sign that is mounted on the display surface and retained in place by upper and lower channel profile members extending longitudinally the length of the shelf.

In an alternative form of the invention, the video device has touch screen capability whereby the content may be selected by touching the screen, obviating the need for the operating buttons.

The shelf also preferably includes a proximity sensor located, for example, in the display surface which activates the video device to play a video when a customer is within a sensed proximity of the shelf.

A security plate that mounts under the shelf may be provided to restrict access to the monitor and other electric components and connections.

The invention will now be described by way of example only with reference to the accompanying drawings in which:

### BRIEF DESCRIPTION OF THE DRAWINGS

FIG. 1 is an isometric view of a shelf embodying the invention without the signs, monitor or control buttons;

FIG. 2 is a vertical section through the shelf shown in FIG. 1;

FIG. 3 is a front elevation of the shelf shown in FIG. 1;

FIG. 4 shows a sign for mounting on the display surface of the shelf of FIG. 1;

FIG. 5 is an isometric view of a second shelf embodying the invention without signs, video device or control buttons;

FIG. 6 is a front view of a sign for mounting on the display surface of the shelf shown in FIG. 5

FIG. 7 is a perspective view of the shelf of FIG. 5 in use, with product, sign, video device and control buttons;

FIG. 8 is a view from below showing the shelf, video device, proximity sensor and the electrical connections of the shelf device shown in FIG. 5-7;

FIG. 9 shows a side elevation of a security plate for use with the shelf device shown in FIG. 5-8;

FIG. 10 shows a plan view of the security plate shown in FIG. 9.

### DETAILED DESCRIPTION OF THE PREFERRED EMBODIMENTS

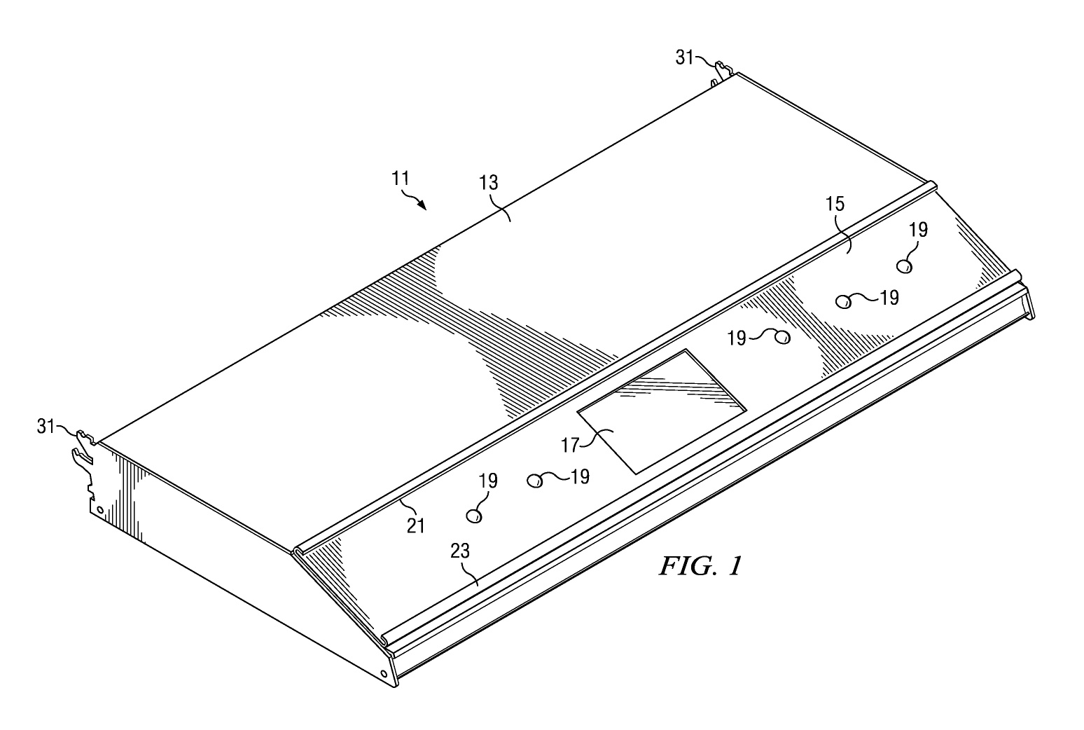

In FIG. 1-3 of the drawings, a shelf 11 comprises an upper, product-supporting surface 13. A display surface 15 extends from the front edge of the surface 13 downwardly and outwardly.

The display surface 15 has a rectangular aperture 17 and five spaced-apart openings 19. A video device (not shown in FIG. 1-3) with built-in speakers is mounted on the shelf 11 with its display screen in register with the aperture 17. The device may be inserted through the opening 17 from the front of the shelf and secured by screws, not shown, passing through a peripheral flange of the device and secured in the display surface 15. The video device can be installed either above or, as is preferred, below the shelf 11. The video device contains a selection of audio/video recordings. Five control buttons (not shown) extend through respective ones of the openings 19 and are operatively connected by electric leads to the video device and control the selection of particular video content stored in the monitor.

Cabling for the video device, connecting it both to the control buttons and a power supply, is accommodated under the shelf.

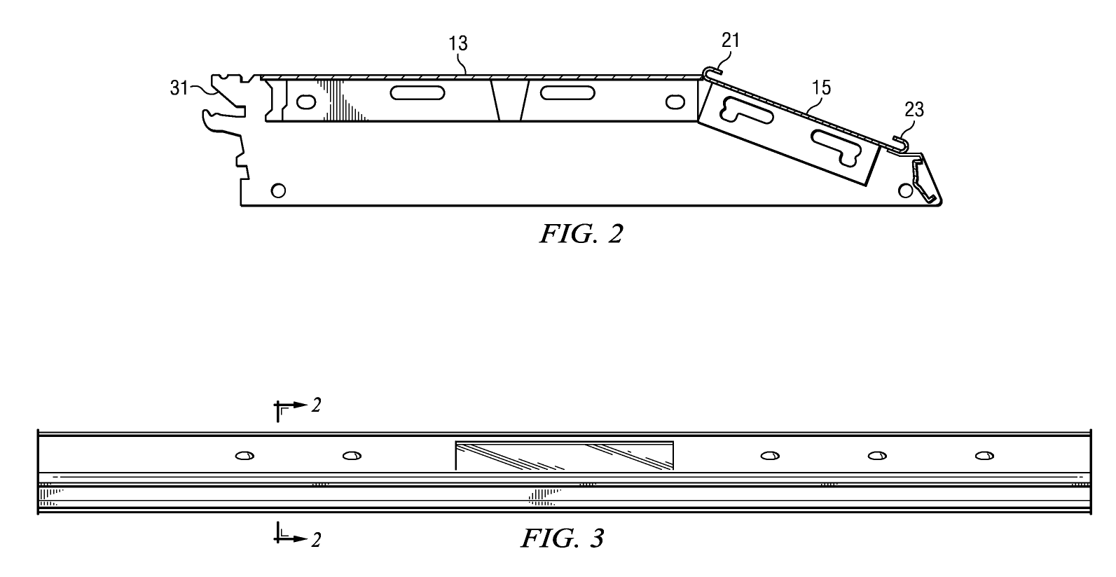

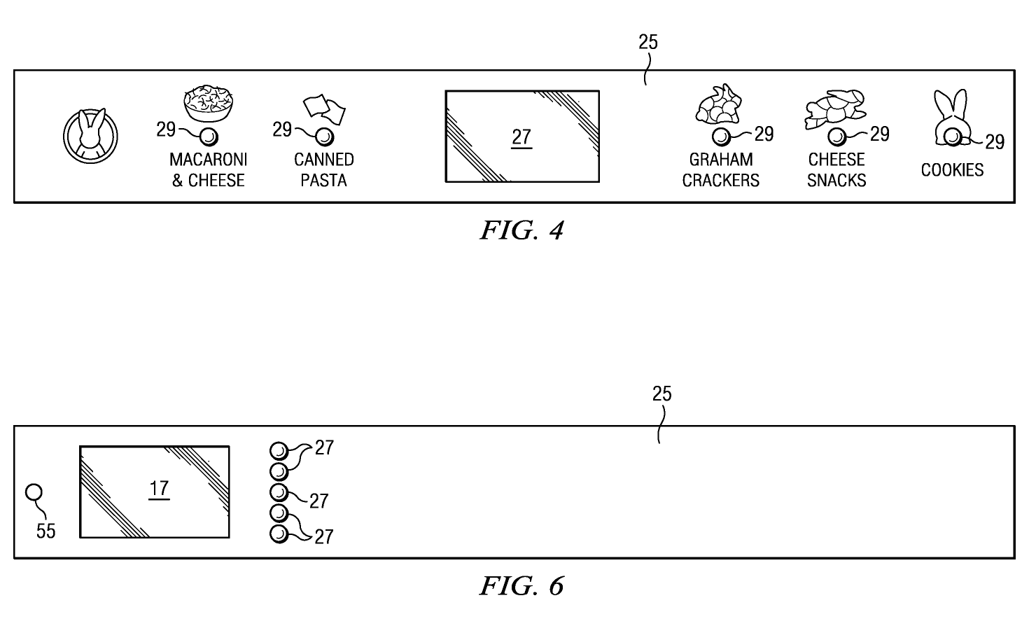

As shown in FIGS. 1 and 2, a pair of upper and lower channel profiles 21 and 23 extends across the display surface 15 and secure in position a rectangular advertising sign 25, shown in FIG. 4. The sign 25 is approximately 6″ by 48″. As seen, the sign 25 has a rectangular opening 27 and five button-receiving openings 29. It will be appreciated that more or fewer openings 19, control buttons and button-receiving openings 29 could be provided in other embodiments of the invention. When the sign 25 is mounted in the channel profiles 21 and 23, the opening 27 is in register with the video display screen of the video device and each of the control buttons extends through a respective one of the openings 29.

The particular graphics shown in FIG. 4 of the sign 25 represent a particular version of the shelf. It will be appreciated that the graphics will vary depending on the video content on the video device and the products on the shelf 13.

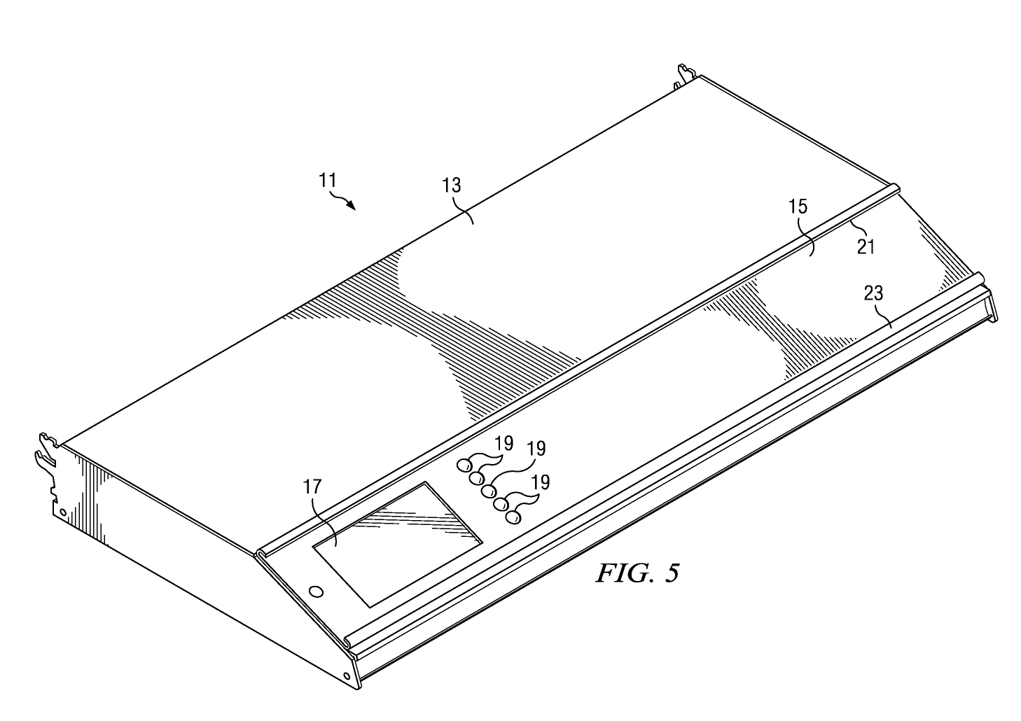

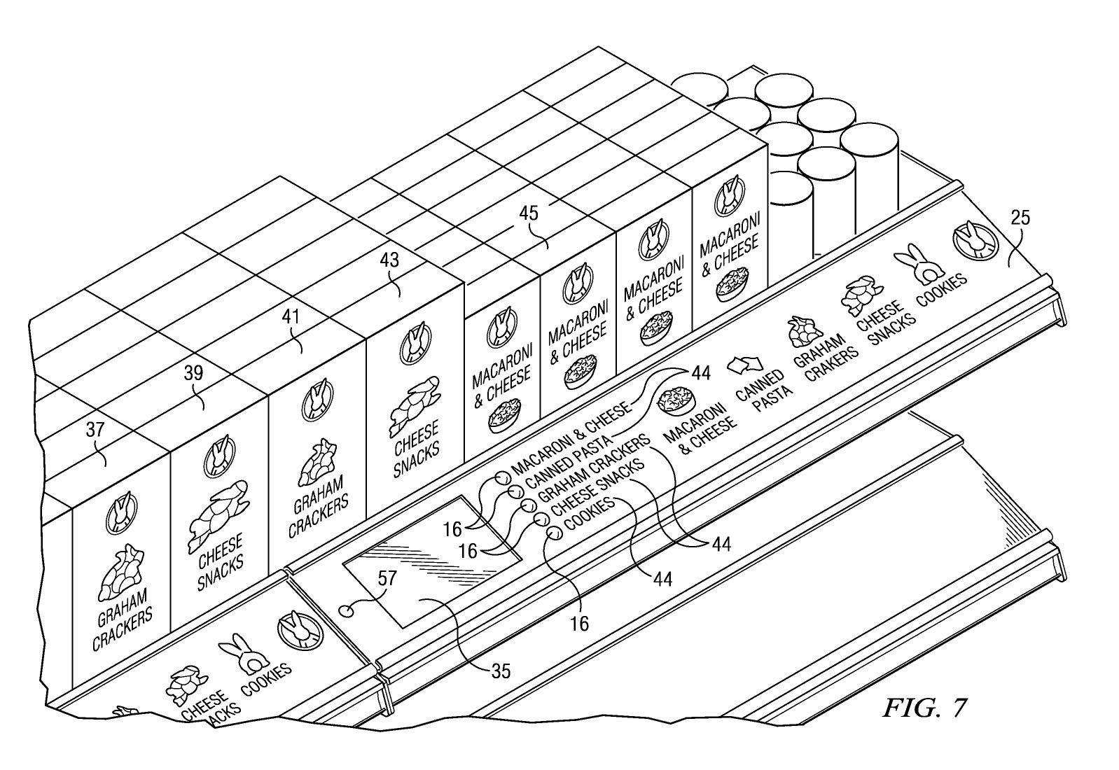

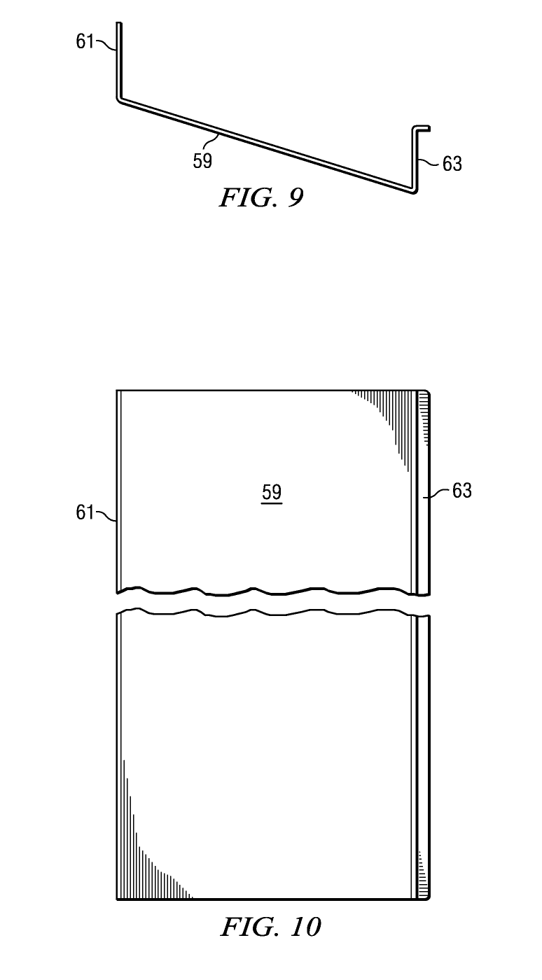

FIG. 5 through 10 show an alternative form of the shelf 11 embodying the invention. Elements of the alternative embodiment that correspond to elements of the first described embodiment of FIG. 1-3 will not be described again and are referred to by the same reference number as in FIG. 1-3. In the alternative embodiment, five control buttons 16 extend through the openings 19 in the display surface 15 all of which are located on one side of the screen of a video device. The sign 25 shown in FIG. 6 has openings 27 in register with the openings 19. It will be appreciated that in other embodiments of the invention fewer than or more than five buttons could be provided.

The video device is a video monitor 18 with a 7 inch LED screen (480 pixels×230 pixels) and two integrated speakers, such as the FVDF7-L1 monitor manufactured by Industrial Images, Inc. The video monitor screen is preferably covered by a transparent protective cover 35.

FIG. 7 illustrates the shelf 11 shown in FIGS. 5 and 6 in use. Five different products 37, 39, 41, 43, and 45 are displayed on the display surface 15. Advertising for the products 37-45 is provided on the sign 25 mounted over the display surface 15 and held by the channel profiles 21 and 23. Each of the five control buttons 16 is associated with a respective one of the products 37-45 and the association is indicated by a respective legend 47 on the sign 25 adjacent each button 16.

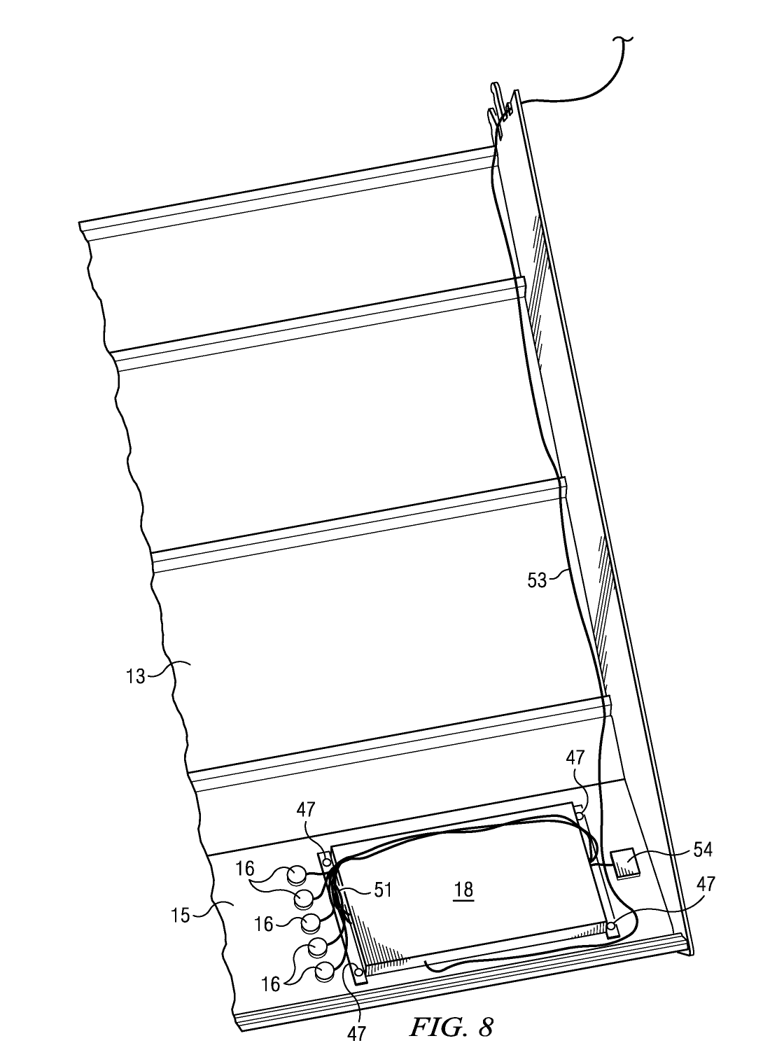

FIG. 8 shows the underside of the shelf 11. As seen, the video monitor 18 is secured by fasteners 49 to the margins of the aperture 17. The control buttons 16 are each connected by leads 51 to the video monitor 18. The video monitor 18 is powered by a supply cable 53 that is connectable at its other end (not shown) to a main power supply of the display fixture on which the shelf 11 is mounted.

A proximity sensor 54 is mounted to the underside of the shelf 11. The proximity sensor 54 is preferably an infrared detector and is operatively connected to the video monitor 18. A lens, not shown, of the infrared proximity sensor 54 is positioned in register with a further opening 55 in the display surface 15 and a further opening 57 in the sign 25 in register with the opening 55 in the display surface 15.

The monitor 18 is connected to an SD video card loaded with a root video and five separate videos, each of which contains video and sound content relevant to a particular one of the products 37-45. In an alternative form of the invention, the video device is connected by a wireless or cellular network to play content that is on a device, or web site remote from the shelf's location, or a mixture of digital content with video playback intermixed.

When the proximity sensor 54 detects the presence of a shopper, it activates the video monitor 18 which plays the root video. Once the root video is playing, the shopper can, by pressing a particular one of the buttons 16, cause a video for a particular product 37-45 to be displayed on the screen of the video monitor 18. When the shelf 11 is idle, between playbacks of video recordings that customers have initiated, the shelf times out and automatically loops a video clip.

Alternatively, the proximity sensor can be arranged to put the video device into a sleep mode to conserve power when no motion is detected. Although the proximity sensor described uses infra-red radiation, it will be appreciated that other forms of proximity sensors can be used, such as micro-wave, or dual wave sensors.

The shelf 11 comprises only the display surface 15 and the support surface 13 and the monitor 18 and the proximity sensor 54 are mounted on the underside of these components. In a preferred form of the invention, a security plate 59 is secured to the shelf 11 to restrict access to the electronic components of the device. As best seen in FIG. 10, the plate 59 has a rear flange 61 and a front flange 63 which together form an enclosure for the monitor 18 and proximity sensor 54. Brackets (not shown) are provided to secure the rear flange 61 to the rear of the underside of the product-supporting surface 13 and the front flange 63 to the underside of the display surface 15 respectively.

In the illustrated embodiments of the invention, the screen of the video device 18 is shown as occupying only part of the display surface 15. It will be appreciated, however, that a screen for the video device could be large enough to occupy substantially all the display surface of the device.

The shelf 11 of FIG. 1-4, or 5-7, is mounted to vertical gondola supports or a perimeter wall shelving system by brackets 31 at the two ends of the shelf 11. Alternatively, the shelf 11 may have brackets adapted to hang the shelf from a horizontal bar which, in turn, has brackets at its ends mounting to vertical supports of a gondola or a perimeter wall shelving system.

Advantageously, the shelf is, in use, located before a large illuminated sign with product graphics relevant to the products features in the video clips. A suitable sign is the Lumicanopy sold by Madix, Inc.

1. A shelf for displaying products comprising
a first supporting surface for displaying products,
a second display surface extending downwardly and outwardly from one edge of the supporting surface,
a video device mounted on the shelf with its screen in register with an opening in the display surface of the shelf,
and brackets for mounting the shelf to a display device with the supporting surface substantially horizontally disposed.

2. A shelf as claimed in claim 1 in which a plurality of controls accessible from the front of the shelf are provided to enable content stored on the video device to be selected and played.

3. A shelf as claimed in claim 1 including a sensor that can detect the proximity of a person to the shelf and which is operatively connected to the video device to initiate playing of content on the video device when the proximity of a person is sensed.

4. A shelf as claimed in claim 1 in which the selection of content to be played on the video device is controlled by touching the screen of the video device.

5. A shelf as claimed in claim 1 including electric supply cables for connecting the video device to a power supply.

6. A shelf as claimed in claim 1 including a sign mounted on the display surface containing information relating to items on the supporting surface of the shelf.

7. A shelf as claimed in claim 1 including a plate mounted across the bottom of the shelf to restrict access to the video device.
